(19) United States
(12) Patent Application Publication
(10) Pub. No.: US 2007/0262290 A1
(43) Pub. Date: Nov. 15, 2007

(54) Water-Absorbent Polymers for Producing Flame-Resistant Compositions

(75) Inventors: Martin Beck, Maxdorf (DE); Samantha Champ, Ludwigshafen (DE); Markus Tonnessen, Ludwigshafen (DE); Antje Ziemer, Mannheim (DE); Dennis Losch, Altrip (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Basf Aktiengesellschaft, Ludwigshafen (DE)

(21) Appl. No.: 11/666,961

(22) PCT Filed: Nov. 4, 2005
(86) PCT No.: PCT/EP05/11822

§ 371 Date: May 2, 2007

(30) Foreign Application Priority Data
Nov. 10, 2004 (DE) 10 2004 054 396.8

(51) Int. Cl. C09K 21/00; C08F 8/00

(52) U.S. Cl. 252/601; 525/384; 525/55

(57) ABSTRACT

The invention concerns water-absorbing polymers for producing fire-retarding compositions, comprising at least one interpolymerized ethylenically unsaturated monomer bearing acid groups, wherein from 51 to 64 mol % of the acid groups are present as carboxylate groups and some or all of the carboxylate groups have potassium ions as counterions, processes for producing the water-absorbing polymers and also the production of fire-retarding compositions and coatings.

The present invention relates to water-absorbing polymers, to processes for producing the water-absorbing polymers and also to the production of fire-retarding compositions and coatings.

Further embodiments of the present invention are discernible from the claims, the description and the examples. It will be appreciated that the hereinbefore identified and the hereinafter still to be more particularly described features of the subject matter of the present invention are utilizable not only in the particular combination indicated but also in other combinations without leaving the realm of the present invention.

One problem in firefighting is that the water used for extinguishing can drain away and hence can only partly be used for cooling the source of the fire. It is therefore necessary to use a very large amount of water, and consequently the damage due to water is often greater than the damage purely due to the fire.

The use of hydrogels as a solution to this problem has been proposed for more than 35 years, for example in EP-A 649 669, U.S. Pat. No. 3,229,769 and U.S. Pat. No. 5,849,210. Hydrogels are produced from a water-absorbing polymer and water. The hydrogel binds the water and so stops the water flowing away from the source of the fire.

EP-A 649 669 describes the use of water-absorbing polymers based on sodium acrylate as a dry extinguishant and as an extinguishant additive in water.

U.S. Pat. No. 3,229,769 discloses hydrogels based on ionically crosslinked potassium polyacrylates useful as fire-retarding coatings.

U.S. Pat. No. 5,849,210 discloses the use for firefighting of hydrogels prepared using water-absorbing polymers based on sodium acrylate having an approximately 75 mol % degree of neutralization.

The present invention has for its object to provide improved water-absorbing polymers.

The present invention further has for its object to provide fire-retarding compositions having elevated stability in storage at elevated temperatures.

The present invention further has for its object to provide fire-retarding compositions which are based on water-absorbing polymers having high swellability and which are inexpensive to produce.

The present invention further has for its object to provide fire-retarding compositions based on hydrogels having improved fire-retarding performance in the dry state.

We have found that this object is achieved by a water-absorbing polymer, comprising
a) at least one interpolymerized ethylenically unsaturated monomer bearing acid groups,
b) at least one interpolymerized crosslinker,
c) if appropriate one or more interpolymerized ethylenically and/or allylically unsaturated monomers copolymerizable with a),
d) if appropriate one or more water-soluble polymers onto which the monomers a), b) and if appropriate c) are at least partly grafted, and
e) if appropriate one or more reacted postcrosslinkers,
   wherein from 51 to 64 mol % of the acid groups of the at least one monomer a) are present as carboxylate groups and some or all of the carboxylate groups have potassium ions as counterions.

Preferably from 54 to 63 mol %, more preferably from 57 to 62 mol % and most preferably from 59 to 61 mol % of the acid groups of the interpolymerized monomer a) are present as carboxylate groups.

Preferably not less than 15 mol %, more preferably not less than 33 mol %, even more preferably not less than 80 mol % and most preferably not less than 95 mol % of the carboxylate groups of the interpolymerized monomer a) have potassium ions as counterion.

Useful monomers for the interpolymerized monomers a), b) and c) include the hereinbelow described monomers i), ii) and iii).

Useful water-soluble polymers for the at least partly grafted water-soluble polymers d) include the hereinbelow described water-soluble polymers iv).

Useful reacted postcrosslinkers e) include the hereinbelow described postcrosslinkers.

Centrifuge retention capacity of water-absorbing polymers is typically not less than 15 g/g, preferably not less than 20 g/g and more preferably not less than 25 g/g. Centrifuge retention capacity is determined according to EDANA's recommended test method No. 441.2-02 “Centrifuge retention capacity” (EDANA=European Disposables and Nonwovens Association).

Preferably, the water-absorbing polymers of the present invention are lightly surface postcrosslinked.

The present invention further provides a process for producing water-absorbing polymers by polymerization of a monomer solution comprising
i. at least one ethylenically unsaturated monomer bearing acid groups,
ii. at least one crosslinker,
iii. if appropriate one or more ethylenically and/or allylically unsaturated monomers copolymerizable with i), and
iv. if appropriate one or more water-soluble polymers onto which the monomers i), ii) and if appropriate iii) can be at least partly grafted,
   wherein up to 40 mol % of the acid groups of the monomer i) are present in the monomer solution as carboxylate groups, the as-polymerized hydrogel is postneutralized so that from 51 to 74 mol % of the acid groups of the interpolymerized monomer i) are present as carboxylate groups and some or all of the carboxylate groups in the postneutralized hydrogel have potassium ions as counterions.

The production of water-absorbing polymers is described for example in the monograph “Modern Superabsorbent Polymer Technology”, F. L. Buchholz and A. T. Graham, Wiley-VCH, 1998, or in Ullmann's Encyclopedia of Industrial Chemistry, 6th edition, volume 35, pages 73 to 103.

Water-absorbing polymers may be prepared by reacting hydrophilic ethylenically unsaturated monomers in the presence of crosslinkers to form a base polymer. The polymerization may also be carried out in the presence of a suitable grafting base, as described in U.S. Pat. No. 5,041,496. The reaction may be carried out for example as a free-radical solution polymerization or inverse suspension polymerization. Free-radical solution polymerization is preferred.

Useful monomers i) include for example ethylenically unsaturated carboxylic acids, such as acrylic acid, methacrylic acid, maleic acid, fumaric acid and itaconic acid, or derivatives thereof, such as acrylamide, methacrylamide, acrylic esters and methacrylic esters. Acrylic acid and methacrylic acid are particularly preferred monomers. Acrylic acid is most preferred.

The water-absorbing polymers are crosslinked, i.e., the polymerization is carried out in the presence of compounds having two or more polymerizable groups which can be free-radically interpolymerized into the polymer network. Preference is given to using crosslinkers ii) having at least one polymerizable group selected from allyl, acryloyloxy and methacryloyloxy, more preferably exclusively. Allyl groups, such as allyl ether and allylamine groups are most preferred. Allyl ether groups are most preferred. The crosslinkers ii) may comprise two, three, four or more, preferably two, three or four and more preferably three or four polymerizable groups. The polymerizable groups in the crosslinker ii) may be the same or different in that for example the crosslinker ii) may comprise at least one acrylic ester group and at least one allyl ether group, at least one acrylic ester group and at least one allylamine group, at least one methacrylic ester group and at least one allyl ether group, at least one methacrylic ester group and at least one allylamine group, two or more acrylic ester groups or two or more methacrylic ester groups, preferably one allyl ether group and at least one allylamine group or two or more allylamine groups, more preferably two or more allyl ether groups.

Useful crosslinkers ii) include for example ethylene glycol dimethacrylate, diethylene glycol diacrylate, allyl methacrylate, trimethylolpropane triacrylate, triallylamine, tetraallyloxyethane, as described in EP-A 530 438, di- and triacrylates, as described in EP-A 547 847, EP-A 559 476, EP-A 632 068, WO 93/21237, WO 03/104299, WO 03/104300, WO 03/104301 and in German patent application 103 31 450.4, mixed acrylates which, as well as acrylate groups, comprise further ethylenically unsaturated groups, as described in German patent applications 103 31 456.3 and 103 55 401.7, or crosslinker mixtures as described for example in DE-A 195 43 368, DE-A 196 46 484, WO 90/15830 and WO 02/32962.

Preferred crosslinkers ii) are ethylene glycol diallyl ether, diethylene glycol diallyl ether, polyethylene glycol diallyl ether, propylene glycol diallyl ether, dipropylene glycol diallyl ether, polypropylene glycol diallyl ether, tetraallyloxyethane, trimethylolpropane diallyl ether, trimethylolpropane triallyl ether, pentaerithritol triallyl ether and pentaerithritol tetraallyl ether. Particularly preferred crosslinkers are tetraallyloxyethane, trimethylolpropane diallyl ether, trimethylolpropane triallyl ether, pentaerithritol triallyl ether and pentaerithritol tetraallyl ether.

Examples of ethylenically unsaturated monomers iii) copolymerizable with the monomers i) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers iv) include polyvinyl alcohol, polyvinylpyrrolidone, starch, starch derivatives, polyglycols or polyacrylic acids, preferably polyvinyl alcohol and starch.

The preparation of a useful base polymer is described in DE-A 199 41 423, EP-A 686 650, WO 01/45758 and WO 03/104300 as are further useful hydrophilic ethylenically unsaturated monomers i).

The reaction is preferably carried out in a kneader as described for example in WO 01/38402 or on a belt reactor, as described for example in EP-A 955 086.

The acid groups of the hydrogels obtained are neutralized to an extent in the range from 51 to 74 mol %, preferably in the range from 56 to 69 mol % and more preferably in the range from 59 to 64 mol %, for which customary neutralizing agents can be used, examples being ammonia, amines such as ethanolamine, diethanolamine, triethanolamine or dimethylaminoethanolamine, preferably alkali metal hydroxides, alkali metal oxides, alkali metal carbonates or alkali metal bicarbonates and also mixtures thereof, and although sodium and potassium are particularly preferred among alkali metals very particular preference is given to potassium hydroxide, potassium carbonate or potassium bicarbonate and also mixtures thereof. Typically, neutralization is achieved by admixing the neutralizing agent as an aqueous solution or else preferably as a solid material. A lower degree of neutralization leads to water-absorbing polymers of reduced swellability. A higher degree of neutralization raises the consumption of neutralizing agent without significantly increasing swellability.

For neutralization of the acid groups can at least partly, preferably to an extent of not less than 15 mol %, more preferably not less than 33 mol %, even more preferably not less than 80 mol % and most preferably not less than 95 mol %, potassium compounds used. A high potassium ion content enhances the water-absorbing polymers' tolerability by plants.

Neutralization may be carried out after polymerization, at the hydrogel stage. But it is also possible for up to 40 mol %, preferably from 10 to 30 mol % and more preferably from 15 to 25 mol % of the acid groups to be neutralized prior to polymerization by adding a portion of the neutralizing agent to the monomer solution and setting the desired final degree of neutralization only after polymerization, at the hydrogel stage. The monomer solution can be neutralized by admixing the neutralizing agent. The hydrogel can be mechanically comminuted, by a meat grinder for example, in which case the neutralizing agent can be sprayed, sprinkled or poured on and then carefully mixed in. To this end, the gel mass obtained can be repeatedly minced for homogenization.

The neutralized hydrogel is then dried with a belt or drum dryer until the residual moisture content is preferably below 10% by weight and especially below 5% by weight, the water content being determined according to EDANA's recommended test method No. 430.2-02 “Moisture content” (EDANA=European Disposables and Nonwovens Association). The dried hydrogel is subsequently ground and sieved, useful grinding apparatus typically including roll mills, pin mills or swing mills. The particle size of the sieved, dry hydrogel is preferably below 1000 μm, more preferably below 900 μm and most preferably below 800 μm and preferably above 100 μm, more preferably above 150 μm and most preferably above 200 μm.

Very particular preference is given to a particle size (sieve fraction) ranging from 106 to 850 μm. Particle size is determined according to EDANA's recommended test method No. 420.2-02 “Particle size distribution” (EDANA=European Disposables and Nonwovens Association).

The base polymers are preferably surface postcrosslinked subsequently. Useful postcrosslinkers include compounds comprising two or more groups capable of forming covalent bonds with the carboxylate groups of the hydrogel. Useful compounds include for example alkoxysilyl compounds, polyaziridines, polyamines, polyamidoamines, di- or polyglycidyl compounds as described in EP-A 083 022, EP-A 543 303 and EP-A 937 736, di- or polyfunctional alcohols as described in DE-C 33 14 019, DE-C 35 23 617 and EP-A 450 922, or β-hydroxyalkylamides as described in DE-A 102 04 938 and U.S. Pat. No. 6,239,230.

Useful surface postcrosslinkers are further said to include by DE-A 40 20 780 cyclic carbonates, by DE-A 198 07 502.2 oxazolidone and its derivatives, such as 2-hydroxyethyl-2-oxazolidone, by DE-A 198-07 992 bis- and poly-2-oxazolidinones, by DE-A 198 54 573.2 oxotetrahydro-1,3-oxazine and its derivatives, by DE-A 198 54 574 N-acyl-2-oxazolidones, by DE-A 102 04 937 cyclic ureas, by German patent application 103 34 584.1 bicyclic amide acetals, by EP-A 1 199 327 oxetanes and cyclic ureas and by WO 03/031482 morpholine-2,3-dione and its derivatives.

Postcrosslinking is typically carried out by spraying a solution of the surface postcrosslinker onto the hydrogel or onto the dry base-polymeric powder. After spraying, the polymeric powder is thermally dried, and the crosslinking reaction may take place not only before but also during drying.

The spraying with a solution of the crosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Useful mixers include for example Lödige® mixers, Bepex® mixers, Nauta® mixers, Processall® mixers and Schugi® mixers.

Contact dryers are preferable, shovel dryers more preferable and disk dryers most preferable as apparatus in which thermal drying is carried out. Useful dryers include for example Bepex® dryers and Nara® dryers. Fluidized bed dryers can be used as well.

Drying may take place in the mixer itself, by heating the jacket or introducing a stream of warm air. It is similarly possible to use a downstream dryer, for example a tray dryer, a rotary tube oven or a heatable screw. But it is also possible for example to utilize an azeotropic distillation as a drying process.

Preferred drying temperatures are in the range from 50 to 250° C., preferably in the range from 50 to 200° C. and more preferably in the range from 50 to 150° C. The preferred residence time at this temperature in the reaction mixer or dryer is below 30 minutes and more preferably below 10 minutes.

The base polymer is preferably lightly postcrosslinked; that is, postcrosslinker concentration is typically below 0.3% by weight, preferably below 0.2% by weight, more preferably below 0.15% by weight and most preferably below 0.1% by weight, all based on base polymer. To achieve a sufficient degree of postcrosslinking, the amount of postcrosslinker used is preferably above 0.01% by weight, more preferably above 0.025% by weight and most preferably above 0.05% by weight, all based on base polymer.

Absorption under a pressure of 2070 Pa (0.3 psi) of lightly postcrosslinked water-absorbing polymers is typically not more than 25 g/g, preferably not more than 23 g/g and more preferably not more than 21 g/g, and their absorption under a pressure of 4830 Pa is not more than 18 g/g, preferably not more than 15 g/g and more preferably not more than 12 g/g. Absorption under pressure is determined according to EDANA's recommended test method No. 442.2-02 “Absorption under pressure” (EDANA=European Disposables and Nonwovens Association).

The degree of postcrosslinking is used to control the tackiness of the water-absorbing polymer. When the degree of postcrosslinking is too low, the particles adhere to each other too much in the swollen state and tend to cake together. When the degree of postcrosslinking is too high, the swollen particles completely lose their tackiness. But optimized tackiness is advantageous for use in firefighting, since the particles are capable of clinging without further auxiliaries to the combustible material to be protected.

The present invention further provides water-absorbing polymers obtainable by the processes described above.

The water-absorbing polymers of the present invention are particularly useful for producing fire-retarding compositions or coatings.

Because their tackiness is controllable via their degree of postcrosslinking, postcrosslinked, preferably lightly postcrosslinked, water-absorbing polymers are likewise useful for producing fire-retarding compositions or coatings. Preference is given to using postcrosslinked water-absorbing polymers whose base polymers were prepared using a crosslinker ii).

The water-absorbing polymers are also very useful as water-retaining agents in agriculture, since the swollen hydrogels possess improved stability in storage. Particle size ranges advantageous for this use are from 75 to 1500 μm, preferably from 106 to 850 μm, more preferably from 150 to 850 μm, and from 500 to 10 000 μm, preferably from 1000 to 4000 μm, more preferably from 1500 to 3000 μm.

The present invention further provides for the production of fire-retarding compositions by mixing at least one water-absorbing polymer with water. The weight ratio of water to water-absorbing polymer is preferably not less than 50:1, more preferably not less than 70:1 and most preferably not less than 80:1, and up to 1000:1, preferably up to 500:1 and most preferably up to 100:1.

The present invention further provides fire-retarding compositions comprising at least one water-absorbing polymer and water, preferably in the abovementioned weight ratios.

It is also advantageous to add dyes or opacifying assistants. Opacifying assistants make the fire-retarding composition cloudy and prevent any interaction between the color of the added dye with the background color. This makes it possible for example in the fighting of forest fires to easily see areas which have already been covered with extinguishant. Preferably, the fire-retarding compositions comprise at least one dye and at least one opacifying assistant.

The concentration of dye in the fire-retarding composition is preferably in the range from 0.005% to 10% by weight, more preferably in the range from 0.01% to 5% by weight and most preferably in the range from 0.015% to 2% by weight.

Of particular advantage are dyes which fade as the fire-retarding composition dries and gradually decompose or are otherwise easily removable, for example by flushing with water.

Useful opacifying assistants include inorganic compounds having a solubility of not less than 0.005 g in 100 ml of water at 25° C., such as mica, chalk, calcium carbonate, titanium dioxide.

Useful opacifying assistants, however, also include polymers or copolymers which are dispersible in the fire-retarding composition, examples being styrene-butadiene copolymers, styrene-vinylpyrrolidone copolymers, styrene-butadiene-acrylonitrile copolymers, polyacrylic acid, polyvinyl acetate, polyvinyl acrylate, starch, polystyrene, polyethyleneimine, polyethylene or polyvinyl alcohol.

It will be appreciated that mixtures of various opacifying assistants may be used as well.

The concentration of opacifying assistant in the fire-retarding composition is preferably in the range from 0.005% to 10% by weight, more preferably in the range from 0.01% to 5% by weight and most preferably in the range from 0.015% to 2% by weight.

As well as water, the fire-retarding composition may further comprise up to 10% by weight and preferably from 0.01% to 10% by weight of organic solvents. Organic solvents can for example hasten the swelling of the water-absorbing polymers in the course of the production of the fire-retarding composition. Useful solvents include alcohols, diols, polyols or glycol ethers. It is also possible to use mixtures of two or more solvents.

The fire-retarding compositions may if appropriate comprise further additives, for example viscosity regulators, dispersing assistants, pH regulators and surfactants. The use level of additives can be up to 10% by weight and preferably from 0.01 to 5% by weight per additive and up to 30% by weight for the sum total of additives, based on the fire-retarding composition.

Viscosity regulators enhance the stability of the fire-retarding composition and improve its performance characteristics. Useful viscosity regulators include thickeners, such as binders, alkali-swellable thickeners, alkali-soluble thickeners and polymeric thickeners. Examples of thickeners are polyvinyl alcohol, water-soluble or water-dispersible cellulose derivatives, such as hydroxyethylcellulose, hydroxypropylcellulose and sodium carboxymethylcellulose, polyethers, urethane-modified polyethers, polycarboxylic acids, polyvinylpyrrolidone, polyalkoxylene derivatives, such as polyethylene glycol ethers and polyethylene glycol distearate, and also sodium alginates. It is also possible to use mixtures of two or more viscosity regulators.

Dispersing assistants can likewise improve the stability and properties of the composition of the present invention. Useful dispersing assistants include for example sodium polycarboxylates, sodium naphthalenesulfonates, ammonium naphthalenesulfonates, polyalkoxylated phenols, fatty acid esters or sodium polyphosphates. It is also possible to use mixtures of two or more dispersing assistants.

pH Regulators can be used to set the pH of the fire-retarding composition, preferably to a value in the range from 6 to 8, which reduces the corrosivity of the composition. Useful pH regulators include for example sodium hydroxide, potassium hydroxide, sodium carbonate, potassium carbonate, sodium bicarbonate, ammonium hydroxide, ammonia, amines, such as triethanolamine or 2-dimethylaminoethanol. It is also possible to use mixtures of two or more pH regulators.

Surfactants can likewise improve performance characteristics. Anionic, cationic and nonionic surfactants can be used.

The fire-retarding compositions may further comprise biocides. Biocides enhance storage stability, especially of aqueous preparations.

It is further possible to add surface area enhancers, such as fibers or pyrogenic silica.

The compositions are useful as extinguishants for firefighting. For example, an aqueous preparation may be set and kept in readiness for firefighting use. But it is also possible for the aqueous preparation not to be produced until it is produced, by diluting with water, during firefighting deployment.

The present invention further provides garments or parts of a built structure which have been coated with a fire-retarding coating comprising a water-absorbing polymer. In this case, it is possible for the coated garments not to be moistened until immediately before use. Garments thus treated are of low flammability due to the large amount of bound water. Coated parts of a built structure may similarly not be wetted with water until during extinguishant deployment. This ensures that the extinguishing water does not run off, but becomes bound to hazarded regions.

Test Methods

Centrifuge Retention Capacity (CRC)

Centrifuge retention capacity was determined similarly to the centrifuge retention capacity test method No. 441.2-02 recommended by EDANA (European Disposables and Nonwovens Association).

To determine centrifuge retention capacity, 0.2000±0.0050 g of dried water-absorbing polymer (particle fraction 106 to 850 μm) were weighed into a teabag 60×85 mm in size, which was subsequently sealed shut. The teabag was placed for 30 minutes in an excess of 0.9% by weight sodium chloride solution (at least 0.83 l of solution/1 g of polymer powder). The teabag was subsequently centrifuged at 250 G for 3 minutes. The amount of liquid retained by the water-absorbing polymer is determined by weighing the centrifuged teabag.

Absorbency Under Load (AUL) 0.7 psi (4830 Pa)

Absorbency under load was determined similarly to the Absorption under pressure test method No. 442.2-02 recommended by EDANA (European Disposables and Nonwovens Association).

The measuring cell for determining the AUL 0.7 psi value is a Plexiglas cylinder 60 mm in internal diameter and 50 mm in height. Adhesively attached to its underside is a stainless steel sieve bottom having a mesh size of 36 μm. The measuring cell further includes a plastic plate having a diameter of 59 mm and a weight which can be placed in the measuring cell together with the plastic plate. The plastic plate and the weight together weigh 1344 g. AUL 0.7 psi is determined by determining the weight of the empty Plexiglas cylinder and of the plastic plate and recording it as W₀. Then 0.900±0.005 g of swellable hydrogel-forming polymer (particle size distribution 150-850 μm) is weighed into the Plexiglas cylinder and distributed very uniformly over the stainless steel sieve bottom. The plastic plate is then carefully placed in the Plexiglas cylinder, the entire unit is weighed and the weight is recorded as Wₐ. The weight is then placed on the plastic plate in the Plexiglas cylinder. A ceramic filter plate 120 mm in diameter and 10 mm in height and 0 in porosity is then placed in the middle of a Petri dish 200 mm in diameter and 30 mm in height and sufficient 0.9% by weight sodium chloride solution is introduced for the surface of the liquid to be level with the filter plate surface without the surface of the filter plate being wetted. A round filter paper 90 mm in diameter and <20 μm in pore size (S&S 589 Schwarzband from Schleicher & Schull) is subsequently placed on the ceramic plate. The Plexiglas cylinder holding swellable hydrogel-forming polymer is then placed with plastic plate and weight on top of the filter paper and left there for 60 minutes. At the end of this period, the complete unit is taken out of the Petri dish from the filter paper and then the weight is removed from the Plexiglas cylinder. The Plexiglas cylinder holding swollen hydrogel is weighed out together with the plastic plate and the weight is recorded as W_{b}.

Absorbency under load (AUL) is calculated as follows:
AUL 0.7 psi [g/g]=[W_{b}−Wₐ]/[Wₐ−W₀]
Absorbency Under Load (AUL) 0.3 psi (2070 Pa)

The measurement is carried out similarly to AUL 0.3 psi. The weight of the plastic plate and the weight together amount to 576 g.

Hot Storage Stability

10 g of the hydrogel obtained in the course of the determination of centrifuge retention capacity were filled into a 50 ml glass bottle. The glass bottle was sealed and stored at 90° C. in a forced circulation drying cabinet. The time to hydrogel deliquescence was measured.

### EXAMPLES

### Example 1

A Lödige VT 5R-MK plowshare kneader (5 l in capacity) was charged with 1 000 g of deionized water and 810 g of acrylic acid. This initial charge was inertized by having nitrogen bubbled through it for 20 minutes. It was then neutralized with 263 g of a 48% by weight, likewise inertized potassium hydroxide solution. This was followed by the addition of 0.65 g of pentaerythrtol triallyl ether and 10 g of sorbitan monolaurate. Dilute aqueous solutions were then added of 2.7 g of sodium persulfate (dissolved in 15.3 g of water) and 0.024 g of ascorbic acid (dissolved in 4.8 g of water) to initiate the polymerization at about 23° C. After the maximum temperature had been reached, the batch was stirred for a further 15 minutes. The hydrogel obtained was subsequently postneutralized with 527 g of a 48% by weight potassium hydroxide solution. The ultimately obtained crumbly gel was then dried in a forced circulation drying cabinet at 160° C. for about 3 hours.

The dried base polymer was ground and classified to 106-850 μm by sieving off over- and undersize.

100 g of the dried base polymer were introduced as an initial charge into a Waring laboratory mixer equipped with an attachment having blunt mixing blades. At a moderate number of revolutions per minute, a syringe was then used to slowly inject (through a hole in the lid of the mixing attachment) 0.07 g of ethylene glycol diglycidyl ether dissolved in 2 g of 1,2-propanediol and 1 g of water with stirring in order that the base polymer may be wetted as uniformly as possible.

The moistened polymer was homogenized by stirring and then heat treated on a watchglass in a forced circulation drying cabinet at 150° C. for 60 minutes. It was finally sieved through a 850 μm sieve to remove lumps.

The hot storage stability of the water-absorbing polymers in the swollen state was 40 hours. Centrifuge retention capacity was 25 g/g and absorbency under a load of 4830 Pa was 11.5 g/g.

### Example 2

Example 1 was repeated except that 0.27 g of methylenebisacrylamide was used in lieu of 0.65 g of pentaerythritol triallyl ether.

The hot storage stability of the water-absorbing polymers in the swollen state was 20 hours. Centrifuge retention capacity was 21 g/g and absorbency under a load of 2070 Pa was 18.6 g/g.

1. A water-absorbing polymer, comprising
a) at least one interpolymerized ethylenically unsaturated monomer bearing acid groups, wherein from 51 to 64 mol % of the acid groups are present as carboxylate groups and some or all of the carboxylate groups have potassium ions as counterions,
b) at least one interpolymerized crosslinker,
c) optionally one or more interpolymerized ethylenically and/or allylically unsaturated monomer copolymerizable with a),
d) optionally one or more water-soluble polymer onto which the monomers a), b), and c) are at least partly grafted, and
e) optionally one or more reacted postcrosslinkers.

2. The polymer according to claim 1 wherein the interpolymerized crosslinker comprises one or more polymerizable group selected from allyl, acryloyloxy, and methacryloyloxy.

3. The polymer according to claim 1 wherein the interpolymerized crosslinker comprises two or more polymerizable allyl groups.

4. A process for producing a water-absorbing polymer by polymerization of a monomer solution comprising
(i) at least one ethylenically unsaturated monomer bearing acid groups,
(ii) at least one crosslinker,
(iii) optionally one or more ethylenically and/or allylically unsaturated monomer copolymerizable with i), and
(iv) optionally one or more water-soluble polymer onto which the monomers i), ii), and iii) can be at least partly grafted,
wherein up to 40 mol % of the acid groups of the monomer i) are present in the monomer solution as carboxylate groups, and the polymerized hydrogel is postneutralized such that from 51 to 74 mol % of the acid groups of the interpolymerized monomer i) are present as carboxylate groups and some or all of the carboxylate groups in the postneutralized hydrogel have potassium ions as counterions.

5. The process according to claim 4 wherein the postneutralized hydrogel is postcrosslinked.

6. (canceled)

7. (canceled)

8. The composition according to claim 21 wherein a crosslinker interpolymerized into a base polymer of the water-absorbing polymer comprises one or more polymerizable group selected from allyl, acryloyloxy, and methacryloyloxy.

9. (canceled)

10. (canceled)

11. A fire-retarding composition comprising at least one polymer according to claim 1 and water.

12. The composition according to claim 11 wherein the weight ratio of water to polymer is not less than 50:1.

13. The composition according to claim 11 that comprises at least one additive selected from the group consisting of dyes and opacifying assistants.

14. A garment coated with a fire-retarding composition comprising at least one polymer according to claim 1.

15. A component which is part of a built structure and coated with at least one fire-retarding composition comprising at least one polymer according to claim 1.

16. (canceled)

17. The polymer according to claim 1 wherein a particle size of the water-absorbing polymer is in the range from 106 to 850 μm.

18. The polymer according to claim 1 wherein a particle size of the water-absorbing polymer is in the range from 1 to 4 mm.

19. A fire-retarding composition comprising a water-absorbing polymer of claim 1.

20. A fire-retarding coating comprising a water-absorbing polymer of claim 1.

21. A fire-retarding composition comprising a postcrosslinked water-absorbing polymer.

22. A agricultural water-retaining agent comprising a water-absorbing polymer of claim 1.
